(19) United States
(12) Patent Application Publication
(10) Pub. No.: US 2021/0397993 A1
(43) Pub. Date: Dec. 23, 2021

(54) GENERALIZED MACHINE LEARNING APPLICATION TO ESTIMATE WHOLESALE REFINED PRODUCT PRICE SEMI-ELASTICITIES

(71) Applicant: PHILLIPS 66 COMPANY, HOUSTON, TX (US)

(72) Inventor: Michael E. Westerman, Cypress, TX (US)

(73) Assignee: PHILLIPS 66 COMPANY, HOUSTON, TX (US)

(21) Appl. No.: 17/350,537

(22) Filed: Jun. 17, 2021

Related U.S. Application Data
(60) Provisional application No. 63/040,991, filed on Jun. 18, 2020.

(51) Int. Cl. G06N 5/04; G06N 20/00

(52) U.S. Cl. CPC G06N 5/04; G06N 20/00

(57) ABSTRACT

Certain aspects of the present disclosure provide techniques for combining multiple machine learning applications in order to train a model of a decision support system to determine an optimal semi-elasticity or elasticity coefficient for a commodity in a highly competitive market structure (e.g., unbranded, wholesale fuels market). Data is obtained from sources and clustered using a plurality of clustering combinations. Once data clusters are generated, the relevant features from each cluster is identified. A correlation coefficient range is established, and for each cluster at each iteration of the correlation coefficient range, a set of regressions are implemented and statistical tests conducted in order to determine an optimal coefficient for each cluster. The set of regressions is also implemented on the selected optimal correlation coefficient and the correlation coefficient and corresponding metric is recorded, from which one correlation coefficient is distributed to a computing device associated with the decision support system.

### CROSS-REFERENCE TO RELATED APPLICATIONS

This application is a non-provisional application which claims the benefit of and priority to U.S. Provisional Application Ser. No. 63/040,991 filed Jun. 18, 2020, entitled “Generalized Machine Learning Application to Estimate Wholesale Refined Product Price Semi-Elasticities,” which is hereby incorporated by reference in its entirety.

### INTRODUCTION

Aspects of the present disclosure relate to machine learning models, and in particular to combining multiple machine learning techniques in order to determine optimal model coefficients.

### BACKGROUND

In a highly competitive commodity market structure, there are multiple competitors seeking to provide a fungible commodity to customers. For example, in the unbranded, wholesale fuels spot market, there are numerous competitors that supply undifferentiated fuels to customers at fuel terminals. The competitors at the fuel terminals set the price for the next day (e.g., in the evening), based on that day's closing price of fuel. In some cases, the prices set for the fuel terminal may be changed. For example, the price set for the fuel terminal can be adjusted if the fuel price is not consistent with the fuel price of competitors. In other cases, the price set for the next day may be unchanged because the entity overseeing the fuel terminal can manage multiple fuel terminals, and such changes are not necessary and/or are too burdensome for the entity to determine.

To set the price daily at fuel terminals, there are numerous factors to consider. Prices can be determined based on the demand for the fuel and supply available of the fuel. For example, when demand is high for the fuel, but supply is low, then the price of the fuel may be high. Alternatively, when the demand is low, but the supply is high, then the price of fuel may be low. Further, price and demand demonstrate autoregressive qualities, and as such, price and demand can be modeled as a function of multiple, previous day's prices and volumes. Additionally, non-price factors can affect the demand for the fuel products. For example, non-price factors can include weather, weather forecast, location, day of the week, month of the year, holiday, etc.

Economic conditions can also influence pricing. There are generally four possible economic conditions: 1) a good economy with high prices, 2) a good economy with low prices, 3) a bad economy with high prices, and 4) a bad economy with low prices. However, to predict pricing for the next day at a fuel terminal based on economic conditions is difficult because while the present economic condition can affect the price, the actual economic condition is not known until after the economic condition has come to pass (e.g., days, weeks, or months from the present day).

Price elasticity of demand describes how much a price change can affect a level of demand (e.g., of fuel) and is generally calculated by dividing the percentage change in quantity demanded by the percentage change in price. For example, if a good or service has high price elasticity, then demand will tend to change significantly relative to the price change. However, if a good or service has low price elasticity (or is relatively inelastic) then the demand will not change as much relative to price changes. Price elasticity can impact revenue in that total revenue of a product or service is estimated to increase or decrease depending on the price elasticity. For example, for relatively price elastic goods, when price is lowered, the revenue could increase with a greater demand at a lower price, such as lowering price of a product unit from $10 to $5 can lead to demand increase from 10 product units to 25 product units, resulting in a revenue increase ($100 to $125). A closely related concept is “semi-elasticity,” which for a log-linear function form can measure a percentage change in the dependent variable when the independent variable changes.

Though the demand for fuel is generally relatively stable over time, the differences between competitors' pricing can affect the amount of fuel sold at a location as well as revenue. Price elasticities are typically calculated with prices and corresponding demand over a certain timeframe. Traditionally, price elasticity is calculated as the percentage change in quantity demanded divided by the percentage change in price. As the differences between the two prices increases (e.g., between two competitors), the accuracy of the estimation of revenue changes and becomes less accurate.

Conventional methods to correct for this fail to provide an explanation for the changing tastes and preferences of consumers from a practical standpoint. Further, conventional methods incorrectly assume that the factors that impact consumers over time are static, when in reality such factors are dynamic (e.g., economic conditions, weather, etc.).

As such, a solution is needed to implement a method for determining a pricing coefficient in a highly competitive commodity market structure that considers factors beyond price.

### BRIEF SUMMARY

Certain embodiments provide a method for training a decision support system. The method generally includes initiating each clustering combination of a plurality of clustering combinations with metric data for each respective clustering combination of the plurality of clustering combinations: clustering the metric data using the respective clustering technique and the respective distance metric to generate a subset of clusters, wherein each cluster of the subset of clusters is associated with corresponding feature data from a superset of feature data; removing from the subset of clusters any cluster having a range of first feature values overlapping any other cluster in the set of clusters by more than an overlap threshold; and adding the subset of clusters to a superset of clusters. The method further comprises performing a unsupervised learning technique on each cluster in the superset of clusters that includes for each respective clustering combination of the plurality of clustering combinations and for each cluster of the superset of clusters associated with the respective clustering combination of the plurality of clustering combinations: identifying a set of relevant features for each cluster in the superset of clusters; storing the set of relevant features for each cluster in the superset of clusters; and determining there is another cluster in the superset of clusters to perform the unsupervised learning technique. The method further comprises upon performing the unsupervised learning technique on each cluster in the superset of clusters, identifying a correlation coefficient range, wherein the correlation coefficient range includes a set of correlation coefficient iterations. The method further comprises for each set of relevant features from each cluster of the superset of clusters and for each correlation coefficient iteration in the correlation coefficient range: implementing a set of regressions on the set of relevant features; conducting a set of statistical tests to generate normality values; storing the results of the set of statistical tests; upon storing the results of the set of statistical tests each correlation coefficient iteration in the correlation coefficient range, selecting the optimal coefficient; and implementing the set of regressions on the set of features corresponding to an optimal correlation coefficient. The method further includes selecting a semi-elasticity coefficient for a delta metric from a set of optimal correlation coefficients to deploy in a live model.

Other embodiments provide systems for training a decision support system, as well as non-transitory computer-readable storage mediums comprising instructions that, when executed by a processor, train the decision support system.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a flow diagram of the method for training a decision support system to determine optimal correlation coefficient, according to an embodiment.

FIG. 2 depicts an example environment of the decision support system, according to an embodiment.

FIG. 3 depicts diagram of clustering of feature data, according to an embodiment.

FIG. 4 depicts a user interface for implementing the optimal correlation coefficient, according to an embodiment.

FIG. 5 depicts a server for training a model to determine the optimal correlation coefficient, according to an embodiment.

FIG. 6 depicts a computing device interacting with the decision support system, according to an embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for machine learning models, and in particular to combining multiple machine learning techniques in order to determine optimal model coefficients (e.g., by training a decision support system to determine the optimal model coefficient).

The training of the decision support system involves retrieving feature data and generating a superset of feature data by applying transformation(s) to the feature data. In parallel (or sequentially), a set of clustering combinations are established, which can include combining a clustering technique (or method) with a distance metric. For example, if there are five clustering methods and five distance metrics, then twenty-five clustering combinations are established. Once the set of clustering combinations are established, each clustering combination of the set of clustering combinations is used to cluster features related to a metric.

For example, if the metric is price, a clustering combination clusters the features related to the metric along with associated feature data from the superset of feature data. This is iteratively done until each clustering combination (e.g., each clustering technique and distance metric) generates a set of clusters to include in a superset of clusters. Additionally, each cluster that is generated is reflective of economic condition(s), illustrating a range of metrics associated with the economic condition, which is ultimately included in determining the elasticity coefficient or semi-elasticity coefficient for predicting the next day's price.

Once the superset of clusters is generated, an unsupervised learning technique is performed on each cluster in the superset of clusters to determine relevant features. This is done in order to reduce the number of features associated with a cluster to a number that is more relevant. For example, the unsupervised learning technique can reduce the features by a factor of 10-40 (e.g., approximately 2,000 features associated with a cluster may be reduced to approximately 50-200). The factor for reducing features is not limited to 10-40, and in some cases, can be greater than 40 or less than 10. As a result, the number features reduced can be greater or less than described above, depending on the resources available at the time of implementing the unsupervised learning technique.

The unsupervised learning technique determines the relevant features for each cluster of features in the superset of clusters (e.g., the unsupervised learning technique is applied iteratively to each cluster generated by each clustering combination). For example, the random forest technique can determine which factors are relevant (or explanatory) based on decision tree(s). As a result of implementing an unsupervised learning technique, a set of relevant features is generated for each cluster in the superset of clusters. After determining a set of relevant features for each cluster, the sets of relevant features are stored (e.g., in a database, list, etc.).

Upon determining the relevant features for each cluster in the superset of clusters, a correlation coefficient range is identified. For example, the correlation coefficient range can be 0.15 to 0.95. In other cases, the correlation coefficient range can include a lower range value to be less than 0.15 or a higher range value to be more than 0.95. For example, the correlation coefficient range can be 0.3 to 0.9. The correlation coefficient range can be any range sufficient to capture data for further analysis. Once the coefficient correlation range is established, a first iteration (or level) from the correlation coefficient range is identified. Based on each set of relevant features determined for a cluster, a set of regressions are implemented at the first iteration (or level). After implementing the set of regressions, the set of relevant features can be further reduced.

Once the regressions are implemented, statistical tests are conducted to determine normality and homoscedasticity values (e.g., p-values). The results of the statistical tests are stored, and the same process is completed with the next iteration (or level). This process of implementing regressions and conducting statistical tests continues until each iteration (or level) of a correlation coefficient range is processed. At such time, an optimal (minimum) correlation coefficient is determined from the correlation coefficient range. Once the optimal (minimum) correlation coefficient is selected, the three regressions can be implemented on the optimal (minimum) correlation coefficient. After implementing the regressions, the resulting elasticity coefficient or semi-elasticity coefficient, corresponding to the metric (e.g., price) is recorded. This process of determining the elasticity coefficient or semi-elasticity coefficient corresponding to the metric continues until each set of relevant features is processed, and there is an elasticity coefficient or semi-elasticity coefficient corresponding to each set of relevant features.

Once the set of elasticity coefficients is determined (and recorded), a price elasticity or semi-elasticity coefficient is determined to be deployed in the decision support system, such as at one of the computing devices associated with the decision support system. The elasticity coefficient or semi-elasticity coefficient provided to each computing device can use the price elasticity or semi-elasticity coefficient to set the price at a fuel terminal location based on factors specific to that fuel terminal beyond just price, regardless of the current economic condition because the initially clustering takes into account each type of economic condition. In some cases, the techniques described herein can be used to determine elasticities or semi-elasticities, depending on the variable transformations. Further, the techniques described herein can reduce the inaccuracies associated with traditional estimation of elasticities or semi-elasticities.

### Example Method for Training a Decision Support System

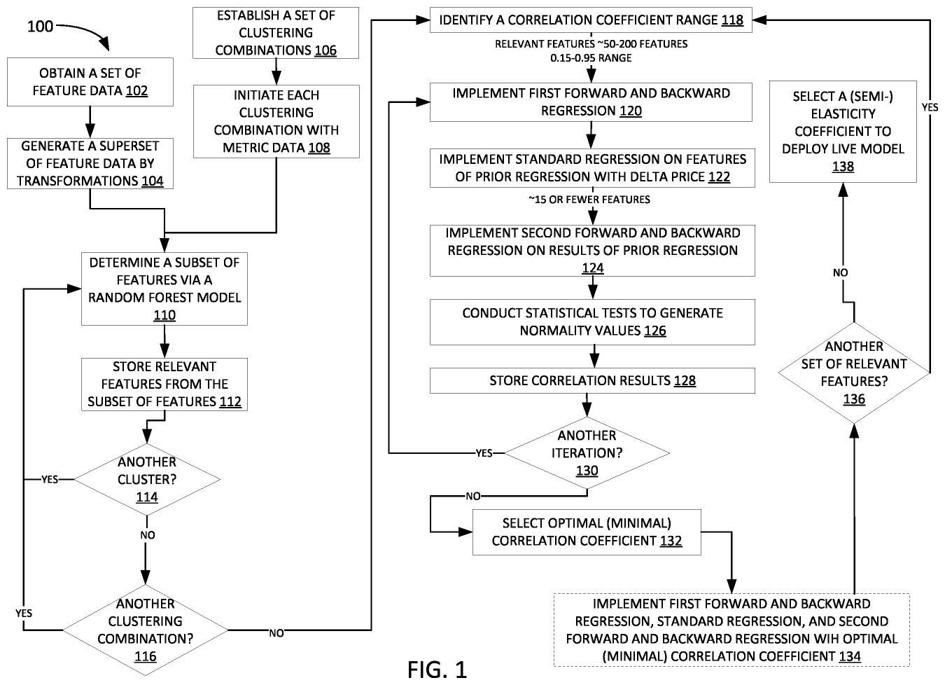

FIG. 1 depicts a flow diagram 100 of training a decision support system. In particular, the decision support system is trained to determine elasticity or semi-elasticity coefficients associated with a metric (e.g., price) for deployment to one or more computing devices associated with the decision support system. Upon deployment, the associated computing device utilizes the metric in establishing operations associated with the computing device.

For example, a computing device associated with a fuel terminal can set the price for the next day's fuel at the fuel terminal in a highly structured commodity market. The decision support system can provide an elasticity or semi-elasticity coefficient to a computing device associated with the fuel terminal. For example, the semi-elasticity coefficient (or the elasticity coefficient) can be an input used by the computing device to calculate an optimal price differential. The computing device can display to an analyst (or entity) associated with the fuel terminal an estimate of fuel gallons that can be sold at a selected price based on the coefficient because the decision support system can take into consideration factors associated with that fuel terminal to determine the coefficient.

The training of the decision support system begins at step 102 by obtaining a set of feature data. In some cases, the sources of the feature data are open data sources. In such cases, an aggregation service associated with the decision support system can gather feature data from the open data source(s) and store the feature data in a data lake or other type of data storage.

The feature data can include internal data. The internal data can describe metric data. For example, the internal data can be metric data associated with an organization's fuel terminal or the published metric (e.g., price) data of competitors' fuel terminals. The feature data can also include external data, such as weather, weather forecasts, commodity spot prices, commodity forward curves, interest rates, and other types of publicly available data that are external to the fuel terminal. In some cases, the feature data is collected on an on-going basis (e.g., daily). Once the set of feature data is gathered, the method proceeds to step 104 in which a superset of feature data is generated based on transformations. In some cases, the feature data in the superset of feature data can be stored as vectors (e.g., in a database, list, etc.).

For example, a plurality of transformations can be applied to the set of features. Some examples of transformations applied can include a time lag transform, a logarithmic transform, a differencing transform, a square root transform, a Box-Cox transform, and so forth. All of the feature data receives the same, applicable transforms to generate the superset of features. In instances where a transform does not apply to one type of feature data, that transform is not applied to any of the feature data.

Upon applying the transformation to the feature data, a superset of features is generated. For example, the initial set of feature data can be multiplied by a factor of about 15-20 to generate the number of features in the superset of feature data. In one example, if there are approximately 100 features in the feature data, then after application of the transformations, the superset of feature data can include approximately 2,200 features. In other cases, the application of transformations on the set of feature data can result in a superset of feature data multiplied by more than a factor of 20 or less than a factor of 15. Such features in the superset of features have high correlation between the features because of the linear transformations of each original feature in the set of feature data.

At step 106, a set of clustering combinations is established, wherein each clustering combination is based on a specific clustering method using a specific distance metric. Based on the identified clustering methods and distance metrics, each clustering method is combined with each distance metric. The set of clustering combinations is established because each methodology and distance can provide different results. Rather than selecting one clustering method and distance metric, a set of clustering combinations is established to determine statistically valid results.

For example, five clustering methods and five distance metrics generate twenty-five unique clustering combinations. Examples of clustering methods include Ward.D2, Single, Complete, Average, McQuitty, Median, Centroid, and kmeans. Examples of distance metrics includes Euclidean, Maximum, Manhattan, Canberra, and Minkowski.

At step 108, each clustering combination is initiated with metric data. Metric data includes features data associated with a metric (e.g., price). For example, the metric data can include data associated with 10-year and 2-year daily yield spread from the U.S. Treasury. Other metric data that is publicly available can also be used when initiating each clustering combination. In some cases, steps 106-108 can occur in parallel to steps 102-104. In other cases, the steps 102-108 can occur sequentially. This case can arise when features need to be retrieved from the superset of feature data to generate the clusters when initiating the clustering combination for data other than metric data (e.g., when metric data is not the basis of the clustering).

The initiation of each clustering combination results in a set of clusters associated with each clustering combination, which in turn, generates a superset of clusters. The features within each cluster of the superset of clusters includes the metric data as well as corresponding feature data from the superset of feature data. The feature data (including the metric data) within each cluster are variables that can exist in an n-dimensional space.

Once the superset of clusters is generated, at step 110, an unsupervised learning technique (e.g., a random forest) is applied to each cluster of the superset of cluster in each clustering combination of the plurality of clustering combinations to determine a set of relevant features for each cluster in the superset of clusters. In some cases, where there is overlap of features between one or more clusters in a subset of clusters, those clusters are removed from the superset of clusters. Step 110 begins with each cluster of a subset of clusters associated with a clustering combination from the plurality of clustering combinations.

The purpose of applying the unsupervised learning technique at step 110 is to narrow down the features in the cluster to those features that are relevant (or rather explanatory) for predicting price. For example, the application of the random forest can reduce features by a factor of 10-40. In some cases, the features can be reduced by more than a factor of 40 or less than a factor of 10, depending on the computer resources available. For example, approximately 2,200 features in a cluster can be reduced to 200 features in that cluster. A set of relevant features of a cluster in the subset of clusters is stored, and the set of relevant features of the next cluster in the subset of clusters can be determined.

At step 114, the determination is made whether there is another cluster in the subset of clusters. If there is another cluster in the subset of clusters associated with the clustering combination, then the method loops back to step 110 and the relevant features are determined and stored at 112. If there are no more clusters in the subset of clusters associated with the clustering combination, then a determination is made at step 116 if there is another clustering combination with an associated subset of clusters. If there is another clustering combination, then the steps 110-114 are repeated until all of the clusters in the subset of clusters associated with the clustering combination have relevant features stored, which results in a superset of relevant features. If there are no more clustering combinations, at step 116, then the method proceeds to step 118.

At step 118, a correlation coefficient range is identified. For example, the correlation coefficient range may be 0.15 to 0.95. In other cases, the range can include a different lower and upper value of the correlation coefficient range (e.g., 0.10 to 0.90).

Once the correlation coefficient range is identified at step 118, then the first iteration (or level) of the correlation coefficient range is identified (e.g., 0.15). With a first set of relevant features from the superset of relevant features (e.g., stored at step 112 for each cluster in the superset of clusters), at step 120, a first forward and backward stepwise regression is performed at the first iteration (or level) of the correlation coefficient range to further narrow down the set of relevant features in a cluster.

At step 122, a standard regression is performed on the results of the first forward and backward regression at step 120. The standard regression is implemented with a delta metric (e.g., a delta price). Prior to step 122, the set of relevant features did not include the metric (e.g., price) because it is highly correlated to the other relevant factors. By excluding the delta metric prior to step 122, the method accounts for all relevant features (other than price which is a feature known to effect demand and price of a product). The addition of the delta metric can explain features that were previously unexplainable and can identify features other than price (in isolation) that explain demand in the commodity market.

At step 124, a second forward and backward stepwise regression is performed on the features in the relevant set of features, now with the delta metric (e.g., price) included to further narrow down the relevant features.

Upon completing the implementation of the second forward and backward regression, the method proceeds to step 126, where statistical tests are conducted. For example, a Shapiro test is conducted to determine the error terms for normality. Another test conducted can be the Breusch-Pagan (BP) test that evaluates the heteroscedasticity (e.g., when a p-value is less than a specified threshold, then the null hypothesis of homoscedasticity is rejected). For example, the Breusch-Pagan tests the null hypothesis that error variances are all equal versus the alternative that the error variances are a multiplicative function of one or more variables. Upon calculating the values using the statistical tests (e.g., p-values), then at step 128, the correlations results of conducting the statistical tests are stored. The results are stored for a later determination of the optimal correlation coefficient.

At step 130, a determination is made whether there is another iteration (or level) in the coefficient correlation range. If yes, then the method proceeds back to step 120 at the next correlation coefficient level. Steps 120-128 are repeated until statistical test results are stored for each iteration of the correlation coefficient range. For example, when the correlation coefficient range is 0.15 to 0.95, after the first iteration at 0.15, the next iterations are 0.16, 0.17, 0.18, etc., until reaching 0.95. In other cases, the iterations can increase by 0.0025, or another increment value. The steps 120-128 are repeated at each increment point in the correlation coefficient range with the first set of relevant features in order to generate enough data to understand what is happening within the range. For example, the method can include iterating through the coefficient range until a lowest correlation coefficient level is determined. Iterating through the coefficient range can prevent overfitting.

The normality and heteroscedasticity values can be recorded at each increment point in the correlation coefficient range. Upon storing statistical test results for each iteration of the coefficient correlation range, the method proceeds to step 132.

At step 132, an optimal (minimal) correlation coefficient is selected for the set of relevant features. In order to do so, the correlation coefficients that meets a set of criteria are determined. For example, the optimal correlation coefficient can be a value that meets the minimum criteria that can be established by statistical tests, such as normality and homoscedasticity. The minimum set of features can be used to prevent overfitting. In some cases, a correlation coefficient that meets a maximum set of criteria can be used instead, as long as each criteria in the maximum set of criteria are met. For example, an optimal correlation coefficient is one that was used to generate results where the p-values for the BP and Shapiro test are greater than 0.05. In some cases, the initial p-values for the BP and Shapiro tests can be a value other than 0.05 (e.g., 0.04, 0.06, etc.).

Upon determining the optimal correlation coefficient, then at step 134, a set of regressions are implemented with the optimal correlation coefficient: a first forward and backward stepwise regression, a standard regression with delta price, and a second forward and backward stepwise regression (e.g., the same set of regressions as steps 122-126). With the second forward and backward regression, the resulting beta coefficient with delta price can be the price semi-elasticity coefficient (or in some cases, the price elasticity coefficient).

For example, the cluster can include 200 features at step 118. In some cases, the initial cluster can include more or fewer features. After implementing the regressions and determining the optimal correlation coefficient at steps 120-132, a reduced number of features can be determined, and the regressions run again with just the reduced number of features at step 134.

In some cases, step 134 can be optional. For example, following the selection of the optimal correlation coefficient at step 132 (e.g., based on normality and heteroscedasticity results), the delta price coefficient and standard error can be recorded. In such cases, once the delta price coefficient and standard error are recorded, the method continues to step 136, and the delta price coefficient can be used at step 138 for determining the elasticity coefficient or the semi-elasticity coefficient.

At step 136, a determination is made whether there are any additional sets of relevant features in the superset of features. If yes, the method proceeds back to step 118 to determine the semi-elasticity coefficient or the elasticity coefficient for each set of relevant features in the superset of features. If no, the method proceeds to step 138, where there is a semi-elasticity coefficient or elasticity coefficient for each set of relevant features (corresponding to each cluster) at every price point.

At step 138, the semi-elasticity coefficient or elasticity coefficient for the delta price is selected to deploy for each metric (e.g., price) point. For example, the semi-elasticity coefficient can be selected based on criteria as illustrated in the table below.

In one example, the values in the following table illustrate the different criteria for determining an elasticity or semi-elasticity coefficient value with a delta price that meets the minimum criteria (or rather, the most restrictive criteria). If there is no coefficient value that meets that criteria, then the restrictions are “loosened” so that a correlation value with a delta price is selected where the p-values for the BP and Shapiro test are greater than, for example, 0.10. If no elasticity or semi-elasticity coefficient value with a delta price is found to exist that meets the updated criteria among the elasticity or semi-elasticity coefficients for each cluster, then the restrictions are “loosened” so that a coefficient is selected where the p-values for the BP (heteroscedasticity) is greater than, for example, 0.05. This process continues of “loosening” criteria until an elasticity or semi-elasticity coefficient value with a delta price is found that matches the criteria.

For example, Level 1 can be the most restrictive criteria, and each subsequent level includes “looser” criteria, with Level 5 as the least restrictive criteria.

| Level 1 | Level 2 | Level 3 |
|---|---|---|
| t-value less than - 2.58 (99%) | t-value less than - 1.96 (95%) | t-value less than - 1.96 (95%) |
| Normality >0.10 | Normality >0.05 | Normality >0.01 |
| Homoskesdaticity >0.10 | Homoskesdaticity >0.05 | Homoskesdaticity >0.01 |

| Level 4 | Level 5 |
|---|---|
| t-value less than - 1.645 (90%) | t-value less than - 1.28 (80%) |
| Normality >0.01 | Homoskesdaticity >0.01 |
| Homoskesdaticity >0.01 | |

In some cases, when more than one elasticity or semi-elasticity coefficient (e.g., from multiple clusters) meets the criteria, to determine which elasticity or semi-elasticity coefficient to provide to the decisions support system, a median value of all of the elasticity or semi-elasticity coefficients determined can be used (e.g., because the elasticity or semi-elasticity coefficients may not be statistically different). Alternatively, an average value of all of the correlation coefficients can be used or the first elasticity or semi-elasticity coefficient that meets the criteria can be used.

In some cases, the model described above, once trained on the data obtained at step 102, can be re-trained periodically when an amount of new data obtained exceeds a pre-determined threshold.

### Example Environment for Operation of the Decision Support System

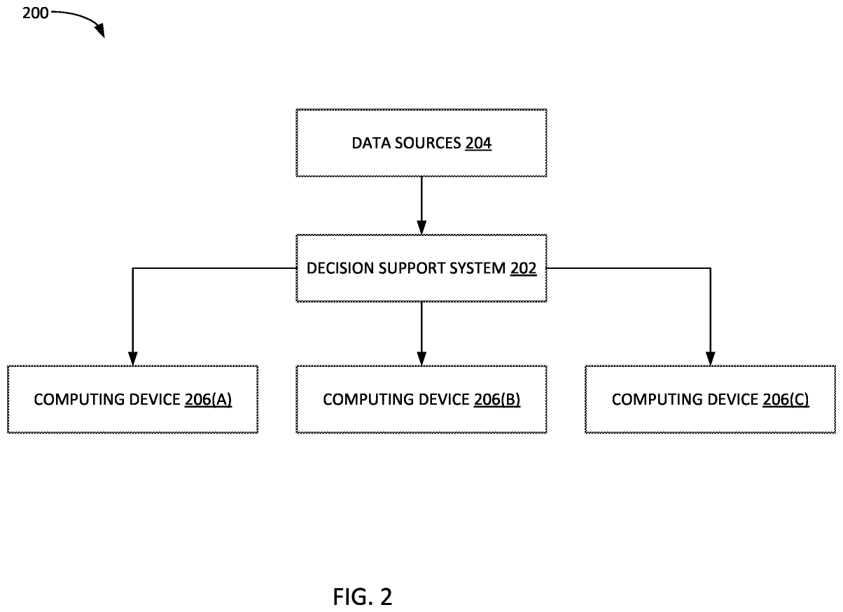

FIG. 2 depicts an example environment 200 for operation of the decision support system. The decision support system 202 can obtain data from data sources 204. The data sources can either be internal or external data sources to an entity associated with the decision support system 202. For example, the entity associated with the decision support system 202 may be a competitor in a highly structured commodity market.

The decision support system 202 may utilize a model trained in accordance with the method of FIG. 1 to determine a metric (e.g., price) coefficient for each computing device 206 that relies on the decision support system 202. For example, computing devices 206(A)-(C) may be associated with a commodity (e.g., a fuel terminal in an unbranded fuel market) and are used by the entity to establish a metric for the commodity.

The computing device 206 can be a computer, laptop, tablet, or other device capable of receiving data from the decision support system. Further, the metric coefficient (an elasticity or semi-elasticity coefficient) received at each computing device is specific to features associated with the corresponding commodity (e.g., geography, weather, etc. at a fuel terminal).

### Example Diagram of Clustering of Feature Data

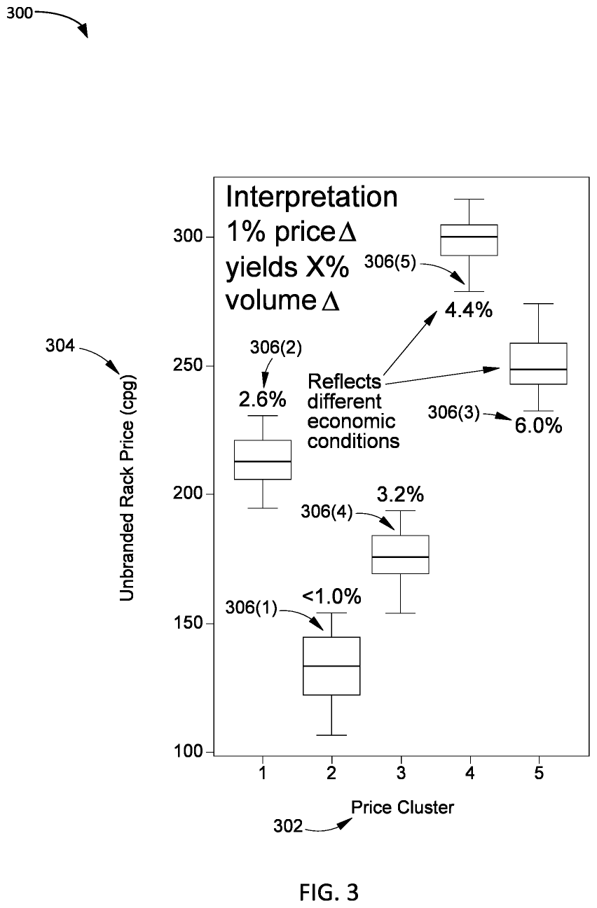

FIG. 3 depicts a diagram 300 of clustering of feature data. For example, the clustered features can be associated with a price of a commodity (e.g., unbranded fuel) or another metric. As illustrated, the x-axis represents a price cluster 302, and the y-axis represents the unbranded rack price (cost per gallon (CPG)) 304. Each cluster 306(1), 306(2), 306(3), 306(4), and 306(5) depicted in the diagram is reflective of a different economic condition.

In this example, there can be four types of economic conditions: 1) a good economy, with high prices; 2) a good economy, with low prices; 3) a bad economy, with high prices; and 4) a bad economy, with low prices. The clusters represent the whole range of economic conditions, which are time-invariant. For example, there are clusters in each of the four economic conditions. As such the correlation coefficient representing price elasticity or semi-elasticity takes into account all 4 economic conditions (since the present economic condition will not be known until after it has passed) to determine which is the elasticity or semi-elasticity coefficient for the present time.

Each cluster 306 illustrated in the diagram is based on a clustering combination, such as k-means clustering and Euclidean distance, as described in FIG. 1, at a different economic condition. Additionally, each cluster 306 illustrates a range in pricing for that economic condition. In some cases, minimal overlap between clusters is acceptable.

### Example User Interface

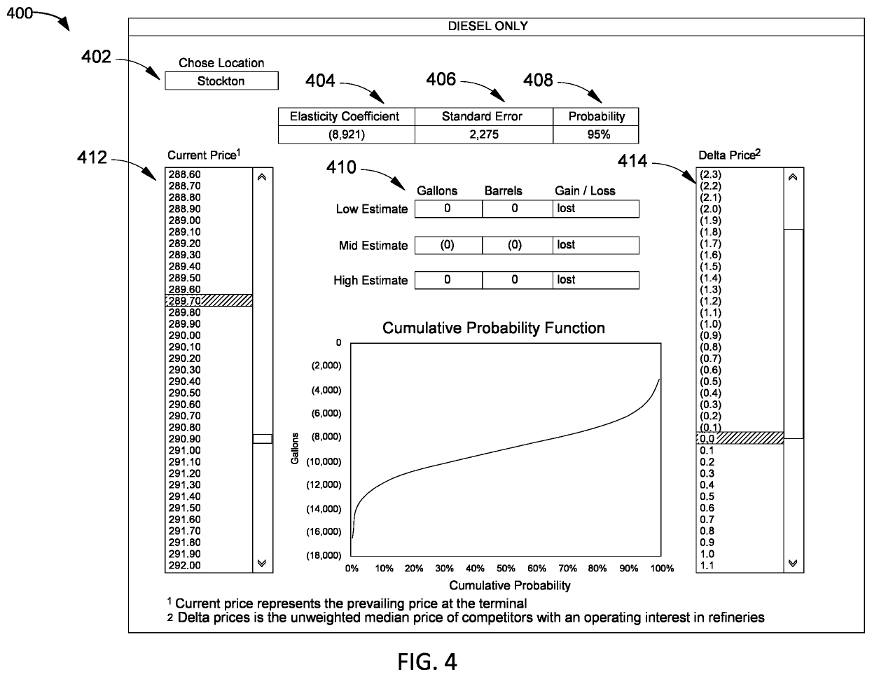

FIG. 4 depicts an example user interface 400 for implementing the optimal correlation coefficient received from the decision support system. Each computing device associated with the decision support system has an instance of the user interface (as illustrated in FIG. 4). With each instance of the user interface 400, a user is able to interact with the user interface 400 to, for example, select a location 402, probability 408, current price 412, and delta price 414.

Additionally, an elasticity coefficient 404 (or semi-elasticity coefficient) associated with price received by the computing device from the decision support system is indicated as well as a standard error 405. Based on the location 402, current price 412, delta price 414, and probability selected 408, as well as the elasticity coefficient 404 and standard error 406 received, a value is displayed in table 410 to the user in the user interface 400 indicating a high, mid, and low estimate associated with gallons, barrels, and gain/loss. In some cases, the delta price is the unweighted median price of competitors. In such cases, the competitors at one fuel terminal may be different than the competitors at a different fuel terminal. As such, the delta price may vary at fuel terminals in different locations.

For example, as illustrated, the following are selected: Stockton (location), 289.70 (current price), 0 (delta price), and 95% (probability). The results are 0 for gallons and barrels, and the gain/loss is “lost” for the low, mid, and high estimates.

### Example Server for the Decision Support System

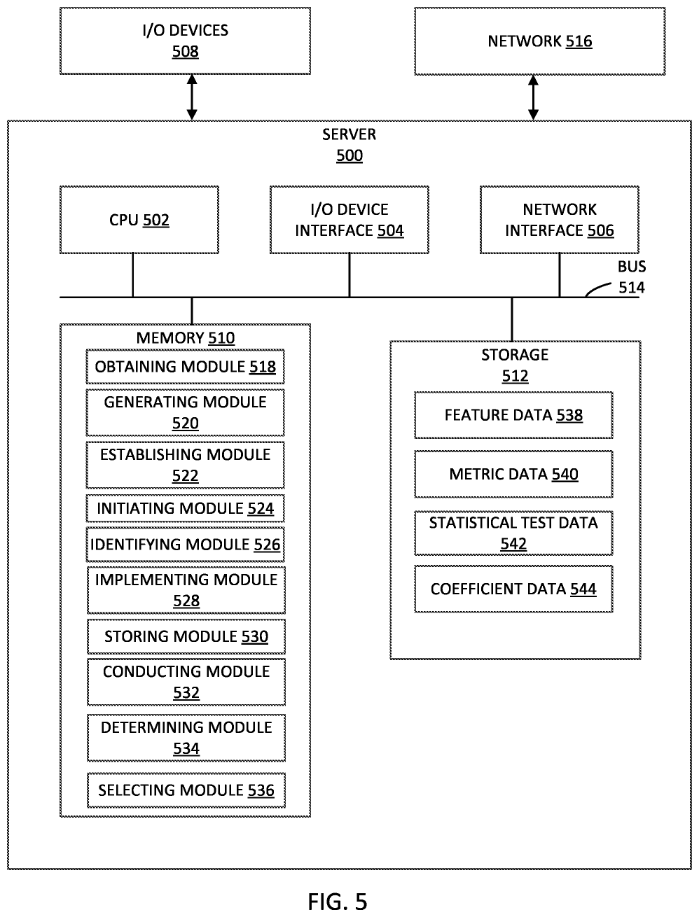

FIG. 5 depicts an example server 500 that may perform the methods described herein, such as the method for training a decision support system, as described with respect to FIGS. 1-3. For example, the server 500 can be a physical server or a virtual (e.g., cloud) server.

Server 500 includes a central processing unit (CPU) 502 connected to a bus 514. CPU 502 is configured to process computer-executable instructions, e.g., stored in memory 510 or storage 512, and to cause the server 500 to perform methods described herein, for example, with respect to FIGS. 1-3. CPU 502 is included to be representative of a single CPU, multiple CPUs, a single CPU having multiple processing cores, and other forms of processing architecture capable of executing computer-executable instructions.

Server 500 further includes input/output (I/O) device(s) 508 and interfaces 504, which allows server 500 to interface with I/O devices 508, such as, for example, keyboards, displays, mouse devices, pen input, and other devices that allow for interaction with server 500. Note that server 500 may connect with external I/O devices through physical and wireless connections (e.g., external display device).

Server 500 further includes network interface 506, which provides server 500 with access to external network 516 and thereby external computing devices.

Server 500 further includes memory 510, which in this example includes obtaining module 518, generating module 520, establishing module 522, initiating module 524, identifying module 526, implementing module 528, storing module 530, conducting module 532, determining module 534, and selecting module 536 for performing operations described in FIGS. 1-3.

Note that while shown as a single memory 510 in FIG. 5 for simplicity, the various aspects stored in memory 510 may be stored in different physical memories, but all accessible by CPU 502 via internal data connections such as bus 514.

Storage 512 further includes feature data 538, which may be like the feature data described in FIGS. 1-3, including such data as the feature data in the superset of feature data.

Storage 512 further includes metric data 540, which may be like the metric data described in FIGS. 1-3, including such data as price data.

Storage 512 further includes statistical test data 542, which may be like the statistical test data described in FIGS. 1-3, including such data as p-values, resulting from statistical tests such as a Shapiro test and a BP test.

Storage 512 further includes coefficient data 544, which may be like the coefficient data described in FIGS. 1-3, including such data correlation coefficient range and correlation coefficients for each iteration of the correlation coefficient range, elasticity coefficients, and semi-elasticity coefficients.

While not depicted in FIG. 5, other aspects may be included in storage 512.

As with memory 510, a single storage 512 is depicted in FIG. 5 for simplicity, but various aspects stored in storage 512 may be stored in different physical storages, but all accessible to CPU 502 via internal data connections, such as bus 514, or external connection, such as network interfaces 504. One of skill in the art will appreciate that one or more elements of server 500 may be located remotely and accessed via a network 516.

### Example Computing Device Interacting with the Decision Support System

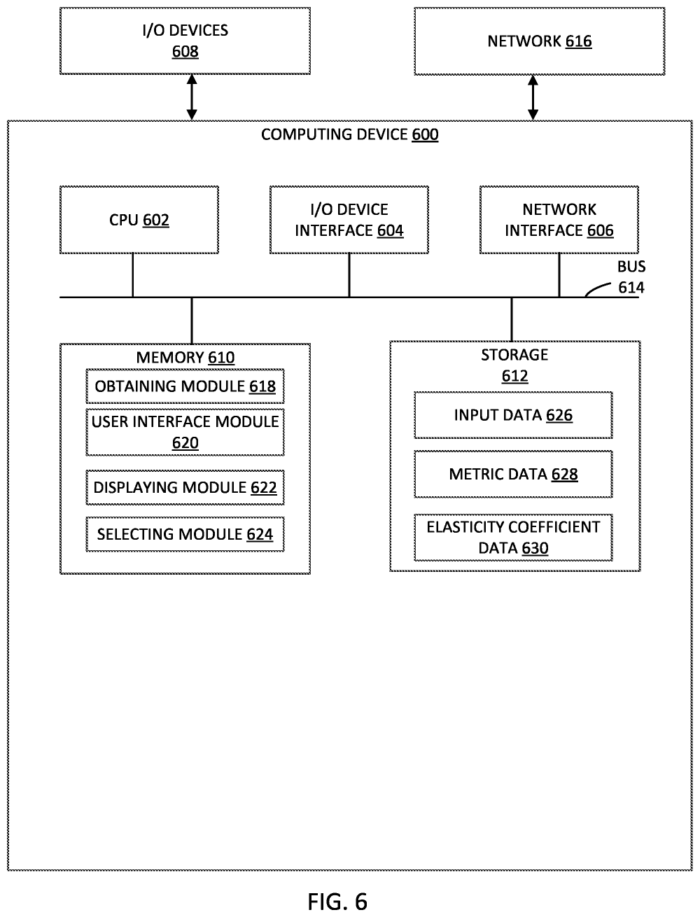

FIG. 6 depicts an example computing device 600 that may perform the methods described herein, such as interacting with a decision support system, as described with respect to FIGS. 3, 4. For example, the computing device 600 can be a computer, laptop, tablet, or other device capable of receiving data from the decision support system.

Computing device 600 includes a central processing unit (CPU) 602 connected to a bus 614. CPU 602 is configured to process computer-executable instructions, e.g., stored in memory 610 or storage 612, and to cause the computing device 600 to perform methods described herein. CPU 602 is included to be representative of a single CPU, multiple CPUs, a single CPU having multiple processing cores, and other forms of processing architecture capable of executing computer-executable instructions.

Computing device 600 further includes input/output (I/O) device(s) 608 and interfaces 604, which allows computing device 600 to interface with I/O devices 608, such as, for example, keyboards, displays, mouse devices, pen input, and other devices that allow for interaction with computing device 600. Note that computing device 600 may connect with external I/O devices through physical and wireless connections (e.g., external display device).

Computing device 600 further includes network interface 606, which provides computing device 600 with access to external network 616 and thereby external computing devices.

Computing device 600 further includes memory 610, which in this example includes obtaining module 618 (e.g., for obtain correlation coefficient from the decision support system), user interface module 620 (e.g., to generate a user interface to interact with the decision support system), displaying module 622 (e.g., to display data at the computing device, including estimated values), selecting module 624 (e.g., to select input values for determining estimated values). Note that while some operations are shown in memory 610, the operations performed by the computing device 600 when interacting with the decision support system are not limited by those described above.

Note that while shown as a single memory 640 in FIG. 6 for simplicity, the various aspects stored in memory 610 may be stored in different physical memories, but all accessible by CPU 602 via internal data connections such as bus 614.

Storage 612 further includes input data 626, which may be like the data input to the computing device as described in FIG. 4, including location, current price, delta price, etc.

Storage 612 further includes metric data 628, which may be like the metric data described in FIGS. 1-4, including such data as price data.

Storage 612 further includes elasticity coefficient data 630, which may be like the elasticity coefficient data described in FIGS. 1-4, including elasticity coefficient and semi-elasticity coefficient data.

While not depicted in FIG. 6, other aspects may be included in storage 612.

As with memory 610, a single storage 612 is depicted in FIG. 6 for simplicity, but various aspects stored in storage 612 may be stored in different physical storages, but all accessible to CPU 602 via internal data connections, such as bus 614, or external connection, such as network interfaces 604. One of skill in the art will appreciate that one or more elements of computing device 600 may be located remotely and accessed via a network 616.

### Second Example

### Insert

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other circuit elements that are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for training a decision support system, comprising:
initiating each clustering combination of a plurality of clustering combinations with metric data for each respective clustering combination of the plurality of clustering combinations:
clustering the metric data using the respective clustering technique and the respective distance metric to generate a subset of clusters, wherein each cluster of the subset of clusters is associated with corresponding feature data from a superset of feature data;
removing from the subset of clusters any cluster having a range of first feature values overlapping any other cluster in the set of clusters by more than an overlap threshold; and
adding the subset of clusters to a superset of clusters;
performing an unsupervised learning technique on each cluster in the superset of clusters that includes:
for each respective clustering combination of the plurality of clustering combinations:
for each cluster of the superset of clusters associated with the respective clustering combination of the plurality of clustering combinations:
identifying a set of relevant features for each cluster in the superset of clusters;
storing the set of relevant features for each cluster in the superset of clusters;
determining there is another cluster in the superset of clusters to perform the unsupervised learning technique;
upon performing the unsupervised learning technique on each cluster in the superset of clusters, identifying a correlation coefficient range, wherein the correlation coefficient range includes a set of correlation coefficient iterations;
for each set of relevant features from each cluster of the superset of clusters:
for each correlation coefficient iteration in the correlation coefficient range:
implementing a set of regressions on the set of relevant features;
conducting a set of statistical tests to generate normality values;
storing the results of the set of statistical tests;
upon storing the results of the set of statistical tests each correlation coefficient iteration in the correlation coefficient range, selecting an optimal correlation coefficient; and
implementing the set of regressions on the set of features corresponding to the optimal correlation coefficient;
selecting a semi-elasticity coefficient from a set of optimal correlation coefficients to deploy in a live model.

2. The method of claim 1, wherein the implementation of regressions includes:
implementing a first forward and backward regression;
implementing a standard regression corresponding to the optimal correlation coefficient with a delta metric; and
implementing a second forward and backward regression on results of the standard regression.

3. The method of claim 1, wherein the results of the first forward and backward regression is a subset of relevant feature from the set of relevant features.

4. The method of claim 1, wherein the method further comprises:
obtaining a set of feature data from one or more data sources;
generating the superset of feature data based on the set of feature data, wherein each feature of the superset of feature data is related to the metric data; and
establishing a plurality of clustering combinations.

5. The method of claim 1, wherein generating the superset of features includes performing one or more transformations on each feature of the set of feature data.

6. The method of claim 1, further comprising: selecting an elasticity coefficient for the delta metric from the set of optimal correlation coefficients to deploy in the live model.

7. The method of claim 1, wherein each optimal coefficient in the set of optimal coefficients corresponds to a set of relevant features from each cluster of the superset of clusters.

8. The method of claim 1, wherein the selection of the optimal coefficient for the set of optimal coefficients includes determining a minimum coefficient level that meets criteria established by statistical testing.

9. A system, comprising:
a processor; and
a memory storing instructions which when executed by the processor perform a method for training a decision support system, comprising:
initiating each clustering combination of a plurality of clustering combinations with metric data for each respective clustering combination of the plurality of clustering combinations:
clustering the metric data using the respective clustering technique and the respective distance metric to generate a subset of clusters, wherein each cluster of the subset of clusters is associated with corresponding feature data from a superset of feature data;
removing from the subset of clusters any cluster having a range of first feature values overlapping any other cluster in the set of clusters by more than an overlap threshold; and
adding the subset of clusters to a superset of clusters;
performing an unsupervised learning technique on each cluster in the superset of clusters that includes:
for each respective clustering combination of the plurality of clustering combinations:
for each cluster of the superset of clusters associated with the respective clustering combination of the plurality of clustering combinations:
identifying a set of relevant features for each cluster in the superset of clusters;
storing the set of relevant features for each cluster in the superset of clusters;
determining there is another cluster in the superset of clusters to perform the unsupervised learning technique;
upon performing the unsupervised learning technique on each cluster in the superset of clusters, identifying a correlation coefficient range, wherein the correlation coefficient range includes a set of correlation coefficient iterations;
for each set of relevant features from each cluster of the superset of clusters:
for each correlation coefficient iteration in the correlation coefficient range:
implementing a set of regressions on the set of relevant features;
conducting a set of statistical tests to generate normality values;
storing the results of the set of statistical tests;
upon storing the results of the set of statistical tests each correlation coefficient iteration in the correlation coefficient range, selecting an optimal correlation coefficient; and
implementing the set of regressions on the set of features corresponding to the optimal correlation coefficient;
selecting a semi-elasticity coefficient for a delta metric from a set of optimal correlation coefficients to deploy in a live model.

10. The system of claim 9, wherein the implementation of regressions includes:
implementing a first forward and backward regression;
implementing a standard regression corresponding to the optimal correlation coefficient with the delta metric; and
implementing a second forward and backward regression on results of the standard regression.

11. The system of claim 9, wherein the results of the first forward and backward regression is a subset of relevant feature from the set of relevant features.

12. The system of claim 9, wherein the method further comprises:
obtaining a set of feature data from one or more data sources;
generating the superset of feature data based on the set of feature data, wherein each feature of the superset of feature data is related to the metric data; and
establishing a plurality of clustering combinations.

13. The system of claim 9, wherein generating the superset of features includes performing one or more transformations on each feature of the set of feature data.

14. The system of claim 13, wherein the method further comprises: selecting an elasticity coefficient for the delta metric from the set of optimal correlation coefficients to deploy in the live model.

15. A non-transitory computer-readable storage medium storing instructions for a method for training a decision support system, the method comprising:
initiating each clustering combination of a plurality of clustering combinations with metric data for each respective clustering combination of the plurality of clustering combinations:
clustering the metric data using the respective clustering technique and the respective distance metric to generate a subset of clusters, wherein each cluster of the subset of clusters is associated with corresponding feature data from a superset of feature data;
removing from the subset of clusters any cluster having a range of first feature values overlapping any other cluster in the set of clusters by more than an overlap threshold; and
adding the subset of clusters to a superset of clusters;
performing an unsupervised learning technique on each cluster in the superset of clusters that includes:
for each respective clustering combination of the plurality of clustering combinations:
for each cluster of the superset of clusters associated with the respective clustering combination of the plurality of clustering combinations:
identifying a set of relevant features for each cluster in the superset of clusters;
storing the set of relevant features for each cluster in the superset of clusters;
determining there is another cluster in the superset of clusters to perform the unsupervised learning technique;
upon performing the unsupervised learning technique on each cluster in the superset of clusters, identifying a correlation coefficient range, wherein the correlation coefficient range includes a set of correlation coefficient iterations;
for each set of relevant features from each cluster of the superset of clusters:
for each correlation coefficient iteration in the correlation coefficient range:
implementing a set of regressions on the set of relevant features;
conducting a set of statistical tests to generate normality values;
storing the results of the set of statistical tests;
upon storing the results of the set of statistical tests each correlation coefficient iteration in the correlation coefficient range, selecting an optimal correlation coefficient; and
implementing the set of regressions on the set of features corresponding to the optimal correlation coefficient; and
selecting a semi-elasticity coefficient for a delta metric from a set of optimal correlation coefficients to deploy in a live model.

16. The non-transitory computer-readable storage medium of claim 15, wherein the implementation of regressions includes:
implementing a first forward and backward regression;
implementing a standard regression corresponding to the optimal correlation coefficient with the delta metric; and
implementing a second forward and backward regression on results of the standard regression.

17. The non-transitory computer-readable storage medium of claim 15, wherein the results of the first forward and backward regression is a subset of relevant feature from the set of relevant features.

18. The non-transitory computer-readable storage medium of claim 15, wherein the method further comprises:
obtaining a set of feature data from one or more data sources;
generating the superset of feature data based on the set of feature data, wherein each feature of the superset of feature data is related to the metric data; and
establishing a plurality of clustering combinations.

19. The non-transitory computer-readable storage medium of claim 15, wherein generating the superset of features includes performing one or more transformations on each feature of the set of feature data.

20. The non-transitory computer-readable storage medium of claim 19, wherein the method further comprises: selecting an elasticity coefficient for the delta metric from the set of optimal correlation coefficients to deploy in the live model.
